(19) United States
(12) Patent Application Publication
(10) Pub. No.: US 2022/0061575 A1
(43) Pub. Date: Mar. 3, 2022

(54) COOKING APPLIANCE FOR COOLING AND HEATING PRODUCTS IN A COOKING CAPSULE

(71) Applicants: Theodoros-Alexandros MARIOGLOU, Skydra (GR); ATHANASIOS KOZADINOS, KALAMARIA THESSALONIKIS (GR)

(72) Inventor: THEODOROS-ALEXANDROS MARIOGLOU, SKYDRA (GR)

(21) Appl. No.: 17/417,140

(22) PCT Filed: Jan. 30, 2020
(86) PCT No.: PCT/GR2020/000011

§ 371 Date: Jun. 22, 2021

(30) Foreign Application Priority Data
Feb. 4, 2019 (GR) 20190100063

(51) Int. Cl. A47J 27/00; H05B 1/02; H05B 6/12

(52) U.S. Cl. CPC A47J 27/004; A47J 27/002; H05B 2203/02; H05B 6/12; H05B 1/0261

(57) ABSTRACT

The invention relates to a cooking appliance using a heat element (2) and a cooling system, which change the temperature of a case (3) inside an outer insulated housing (1). A cooking capsule (4) comprising the food is inserted into the case. The device operation is controlled by a control system (35). Different types of heat elements (2) can be used and corresponding cases (3) are provided respectively. Each cooking capsule (4) has a food holding surface (29), a distillate case (24) and a press (25) for inserting and extracting the food.

### FIELD OF ART

The invention relates to the field of human needs and more particularly to the field of foodstuffs, and in particular to cooking and cooking appliances. It also refers to appliances for kitchen and cooking using cooling or heating, in a capsule.

### BACKGROUND OF THE INVENTION

The cooking appliance disclosed in the present invention using food cooling and heating in a cooking capsule has not been disclosed in the prior art.

Known state-of-art appliances are such as those disclosed in US 2015/0320253, which refers to an egg boiling appliance. Similarly, appliances such as those of U.S. Pat. No. 8,847,123 and US 2015/0010684, relating to product cooking, have been provided, the former one intended for elongated form products, while the latter refers to food cooking, such as sausages, where usually a raw edible product is surrounded by a membrane or another edible product.

Although technology has rapidly developed in almost all areas of our daily life, cooking methods remain largely unchanged to this day. Usually the food is placed in a utensil and cooked either on a stove or in the oven. This means that the user must constantly watch the food and usually take care to adjust its temperature according to the time elapsed and the cooking desired. This inevitably creates a number of difficulties, as the food can be baked excessively and stuck to the utensil because the temperature was too high, or it may be overcooked resulting in its drying and losing its tasty fluids. Usually, especially young cooks, end up with foods that can be partially baked externally and unbaked internally, which in addition to the tasty effect, can sometimes even endanger the consumer's health.

An additional disadvantage to date with traditional cooking methods is the number of settings required to allow the cook to achieve the desired effect. These, in addition to temperature, relate to the way the oven is heated, for example, or the fact that a pot should be open or closed.

Another disadvantage is the frequent need to clean a large number of equipment and utensils used by the cook during the cooking process. In addition, stoves or ovens require frequent and painful cleaning of fats and impurities that remain and become solid over time.

It is thus an object of the present invention to address the aforementioned disadvantages and drawbacks of the prior art by proposing a cooking appliance using product cooling and heating in a cooking capsule.

It is a further object of the present invention to provide a cooking appliance using both heating and cooling.

It is a further object of the present invention to provide such a cooking appliance employing a cooking capsule in which the food to be prepared is inserted.

A further object of the invention is to provide a device having a cooking control system, which is manually adjustable, giving the user the opportunity to cook according to their preferences. Using manual control the user enters the cooking stages, that is, the time periods and temperatures to maintain the case or the removable heat sensors, as well as the times and temperatures that will trigger the automations, such as the cooling system and/or alarm system. Another object of the invention is to provide a cooking device with an automatic control system, which offers thermodynamic modelling of the cooking process.

It is a further object of the invention to provide an appliance in which both liquid and solid foods can be prepared.

It is another object of the invention to present a cooking appliance having removable parts, such as the case and the cooking capsule, thereby making it easy to clean each individually.

It is also an object of the present invention to provide a cooking appliance which can use different methods for heating and cooling the case, achieving both the desired tasty results and the desired power consumption.

A further element of the invention is that it has support and connection means to other devices, such as corresponding cooking devices, or interactive devices such as monitors and mobile phones.

These and other objects, features and advantages of the invention will become apparent in the following detailed description.

### BRIEF DESCRIPTION OF THE DRAWINGS

The invention will be apparent to those skilled in the art with reference to the accompanying drawings illustrating it in an indicative and non-limiting manner.

FIGS. 1(a)-(c) show different forms of the outer housing of the appliance and various illustrative embodiments thereof

FIG. 2 is a cross-sectional view of the inside of the housing, with the capsule case and the intermediate insulation. FIGS. 3(a)-(g) show illustrative embodiments of detachable cases for capsules according to embodiments of the invention.

FIGS. 4(a)-(e) show variations of covers or pads fitted to partially or fully cover the top or the base of the appliance.

FIG. 5 shows the natural air flow around the capsule case, for the purpose of heat dissipation and cooling thereof.

FIG. 6 is an illustration showing the air flow inside the appliance.

FIG. 7 is an illustrative embodiment of the invention, wherein the capsule case cooling is achieved by water cooling, thanks to the use of tubes surrounding it.

FIGS. 8(a)-(b) show illustrative components that cool the water cooling circuit coolant.

FIGS. 9(a) and (b) are an illustration of a cooking capsule having a cylindrical shape as well as the respective section thereof.

FIG. 10 shows the transfer handle of the distillate case, while FIG. 11 shows the press through which the food is squeezed inside and outside of the capsule.

FIGS. 12(a) and (b) illustrate the food as it is squeezed into the capsule and extracted from the capsule, respectively. The distillate case is also displayed.

FIG. 13 illustrates the control system and the power supply of the appliance.

FIG. 14 illustrates the flexible, mobile heat sensors, which are part of the appliance control system.

### BRIEF DESCRIPTION OF A PREFERRED EMBODIMENT

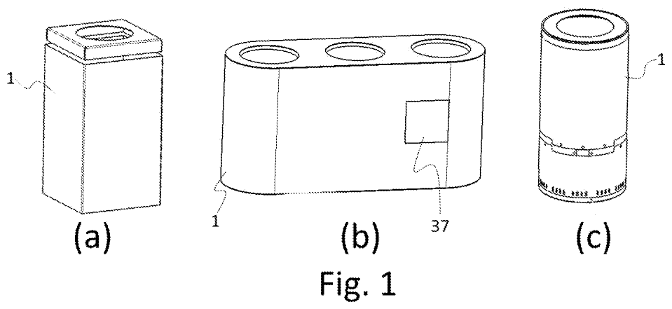

Referring now to the accompanying drawings, we will describe exemplary embodiments of the cooking appliance for cooling and heating products using a cooking capsule. The appliance consists of an outer housing (1), FIG. 1, which surrounds it in whole or in part and which may have different sizes and different shapes, depending on the design of the appliance. Illustrative configurations of the housing (1) are shown in FIGS. 1(a)-(c). The outer housing (1) is made of suitable heat insulating material to protect the user from the heat generated by the appliance. It also protects the appliance from falls, bumps, and other damage. In addition to the outer housing (1) there may be integrated means of interaction with the appliance, as well as indication means such as power buttons, display screens and temperature or time measuring indicators.

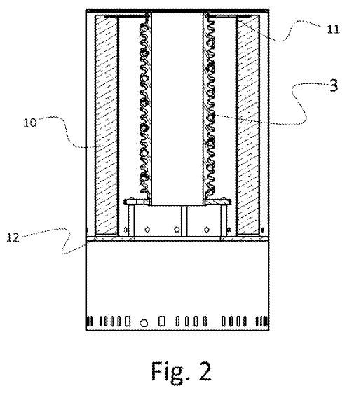

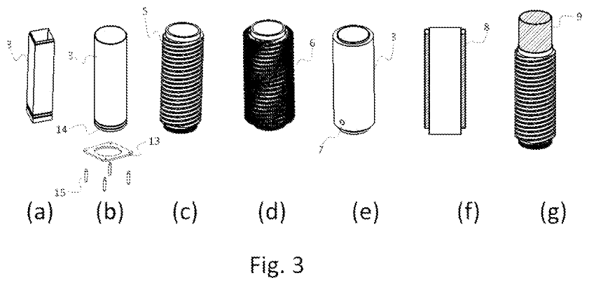

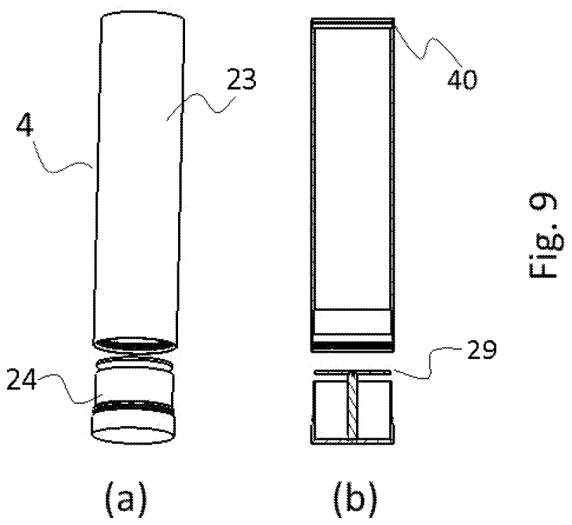

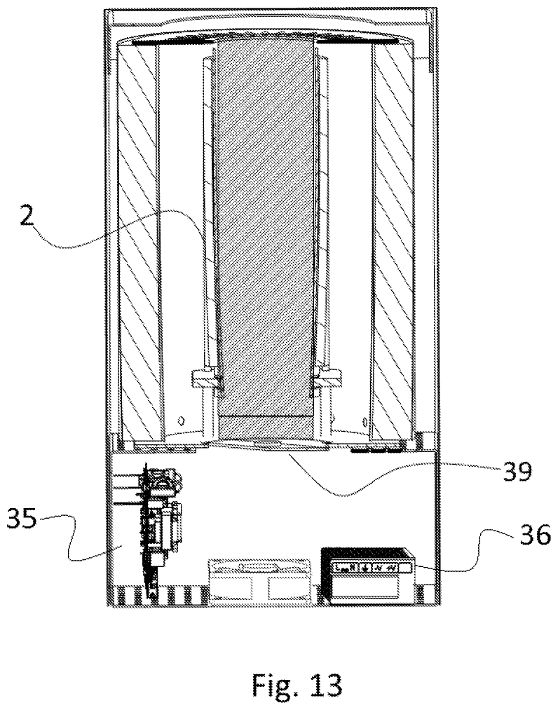

Furthermore, inside the housing (1), the appliance has at least one heat source, through a suitable heat element (2), FIG. 13, which transmits its heat to one or more cases (3), FIG. 2, for cooking capsules. The case (3) may have a different configuration, both in shape and dimensions and externally. The shape of each case (3) depends on several factors. A cooking capsule (4), FIG. 9 (a), is inserted into each case (3), which carries the food to be prepared. Heat is therefore transmitted from the heat element (2) to a part or the entire outer surface of the case (3) and from there it is transmitted to the capsule (4).

The case (3), as aforementioned, may be of different shapes, such as of a cuboid, FIG. 3(a), or a cylinder shape, FIG. 3(b). Suitable cooking capsules (4) are respectively inserted into each case (3). Given that part or the entire capsule (4) can be placed inside the case (3), provision is made that the respective capsule, even at its maximum temperature, and thus in its maximum expansion, should fit in a case being at a minimum temperature and therefore in its maximum contraction. Determining the right shape is not just an issue of aesthetics nor does it just concern the respective capacity but it also defines how each meal is prepared. This is because heat is transmitted differently to each shape. Therefore a cylindrical case (3) will present high velocity and uniformity in heat transfer from the outer surface of the case (3) to the centre thereof. Equal importance is given to the materials used for the case (3) and the cooking capsule (4), since the requirements on thermal properties, such as heat capacity and heat transfer, are important elements in developing a thermodynamic model for the automatic and/or manual control of the cooking parameters. Consequently, for example, manufacturing an aluminum case (3) requires greater thickness than a similar case made of stainless steel if both are to have the same heat capacity and heat transfer rate.

The heat element (2) respectively determines both the shape of the appliance and the case (3) used. Conventional electric heat resistors of all types and shapes, positive temperature coefficient heat elements, with fluid transferred through a closed pipe circuit to the surface or the inner walls of the case (3), with a flame through a gas fuel device, either by heat induction or even by charcoal can be used as a heat element (2). It is possible for the structure to carry more than one type of heat elements (2). Selection of the appropriate element depends on factors such as the energy efficiency of each source, the thermal power required to achieve the appropriate cooking temperatures, the type of food, and of course the cost of manufacture and operation.

If, for example, a resistance spiral or a spiral shaped tube is to be used to provide fluid to heat or cool the case (3), then it may be provided with an outer thread (5), FIG. 3 (c), for higher thermodynamic efficiency. There may also be multiple outer threads (5) for using more heat elements (2). Alternatively, the case (3) may have protrusions (6) externally, FIG. 3 (d) for a larger outer surface and thus faster heat transfer. Further alternatively it may be provided with external inlet / outlet holes (7), FIG. 3 (e) and internal cavities (8), FIG. 3 (0, so that fluid for cooling or heating the case (3) passes through it. An additional alternative embodiment provides that the case (3) has a detachable inner member (9) for convenience of washing, FIG. 3(g). The detachable member (9) may be of different material, taking into account the different thermodynamic properties of each material.

Between the outer housing (1) and the case (3) there is an insulating material (10), FIG. 2, which contributes to proper heat maintenance. Further, the case (3) is preferably detachable so that it can be washed and cleaned as also the interior of the appliance. For this reason, the case (3) can be connected to the appliance in any technically feasible manner. This means that it can be mounted on the inner cover (11) of the appliance, or alternatively on the central base (12) of the appliance, or even on an additional base (13). Further, a thread (14), FIG. 3(b) may be provided to screw the case (3) onto the device. Alternatively it can be supported even with the use of spacers (15) on the additional base (13). The spacers (15) can be used to support and connect different components within the appliance to create gaps for air passage or to reduce contact surfaces between the components. This can change the heat transfer according to the design and construction requirements.

Insulation (10) contributes to the transfer or reduced heat transfer from the heat element (2) to the case (3) and thus to the capsule (4). Consequently, vacuum, air or some insulating material may be in between the outer housing (1) and the heat element (2) in at least one layer. The insulating material has the appropriate heat insulation or reflection properties to reduce heat loss to the environment while also reflecting heat from the inside of the outer housing (1) to the case (3).

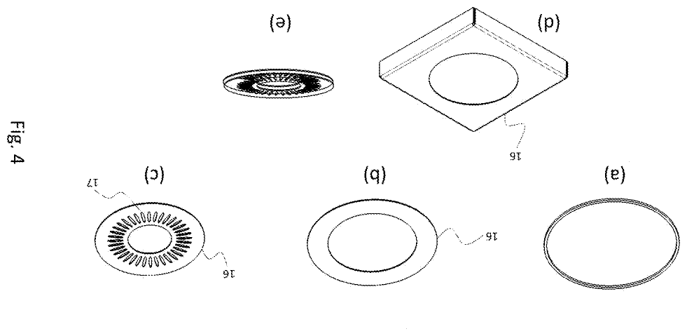

The appliance may be provided with covers (16), FIG. 4(a)-(e), both at the central base (12) and at its top and bottom. The covers are made of suitable materials to meet the insulation and reflection needs of the device, while also contributing to the extraction of heat from the inside of the device outwards. They may therefore be provided with slots (17), FIG. 4(c) from which the hot air exits from inside the device to outside, or cold air enters from the base (12) of the device to its interior. It goes without saying that there may be a design of concentric covers(16), where one rotates relative to the other, so that the slots (17) are aligned, allowing air to pass, or closed, preventing air from passing, as appropriate.

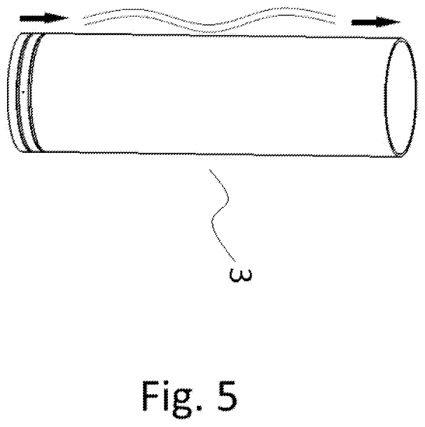

The appliance may furthermore have a cooling system, which may help to better regulate the temperature and thus the food cooking. The cooling system can operate either by air or by water or a combination thereof. Air cooling can be done by natural or forced flow. As is known, natural flow cooling, FIG. 5, occurs because of heat transfer by convection, where the temperature difference of a material relative to the ambient air temperature creates an air flow on the surface of the material, resulting in heat extraction.

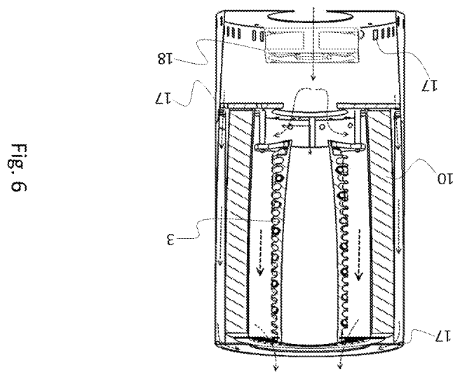

In this way, the air layers adjacent to the warmer surface are heated, thus moving upwards, and are replaced by other cooler air layers, thereby dissipating heat from the warmer material to the ambient. The use of protrusions (6), FIG. 3(d) can work in an auxiliary manner by cooling the case (3) faster, since the blades act as brushes under the air flow. In addition, the presence of covers (16) with apertures (17) can create air flow inside the appliance, FIG. 6, while additional apertures (17) between the inner parts constituting the appliance may direct air into its parts desirable to be cooled, such as in the gap between the housing (1) and the outer surface of the insulation (10), to keep the housing cool even after continuous use of the device. Similar apertures may also exist in the gap between the insulation inner wall (10) and the case (3), in order to accelerate its transition from a warmer stage to a less warm one.

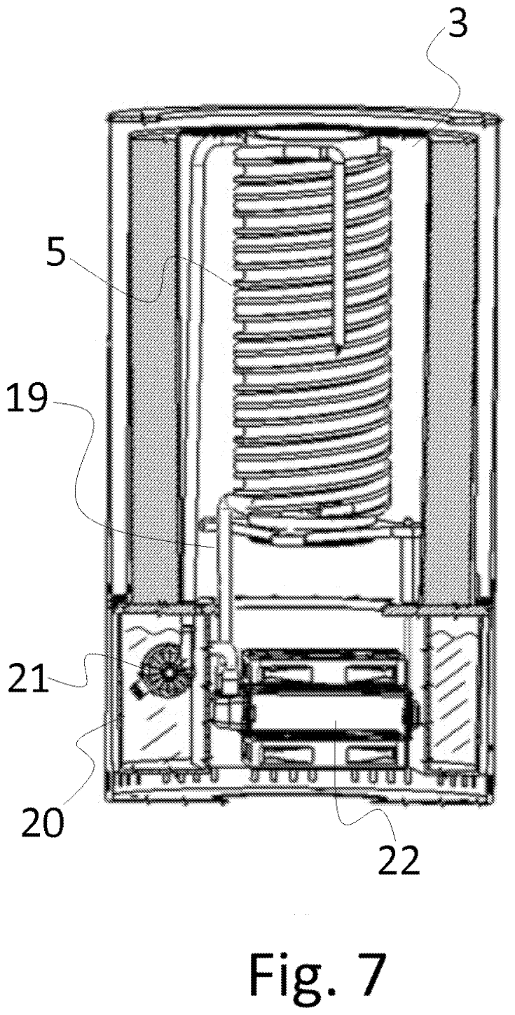

If forced airflow is now envisaged, it is necessary to use components such as fans or air pumps to increase flow to the parts to be cooled. Such a potential alternative is to mount a fan (18), FIG. 6, at the bottom of the device. An alternative cooling application of the device may include water cooling, by transferring liquid to the points we wish to cool by means of a closed piping circuit. The pipes (19), FIG. 7, fit to the thread (5) of the case (3), directly cooling its surface. Similarly to the foregoing, there may be multiple threads (5), while the pipes (19) used to cool the case (3) may also be used for heating through the heat element (2). In such a case it is necessary to use automations to alternate cold and hot liquid in the piping circuit (19). An open or closed tank (20) may be in the piping circuit (19). The tank (20) can be fitted inside or outside the appliance. A fluid circulation means (21), such as a pump, is also situated in or out of the appliance with a view to water circulating. In the case that the fluid intended for the piping circuit (19) is water, its circulation may be directly achieved under the water-supply network pressure by connecting the latter to the appliance piping circuit (19).

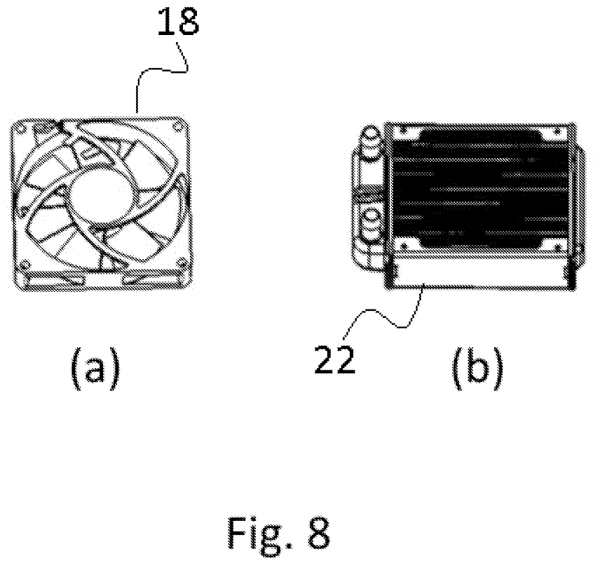

Cooling of the liquid circulating in the piping (19) is achieved by means of cooling devices such as fans (18), a radiator (22), brushes, a thermoelectric generator, cooling gas compression devices or some other means for the purpose of cooling the fluid in the piping (19). The combination of such mechanisms can create a hybrid mechanism whereby, for example, fans (18), FIG. 8(a) in conjunction with a radiator (22), FIG. 8(b), can cool the fluid circulating through the radiator when the circulation means (21) works, this air moving then inwards the appliance and cooling the outer surface of the case (3).

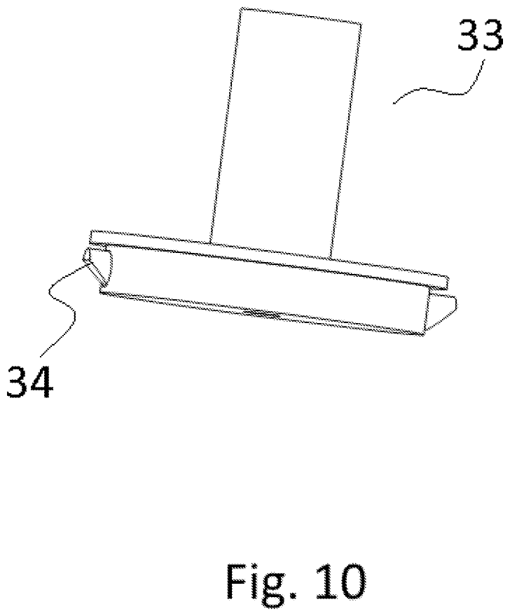

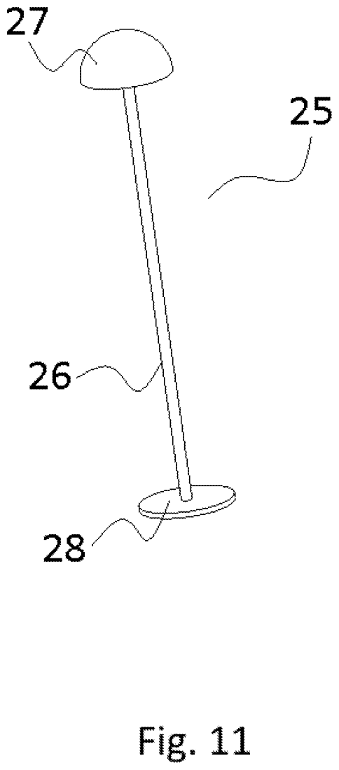

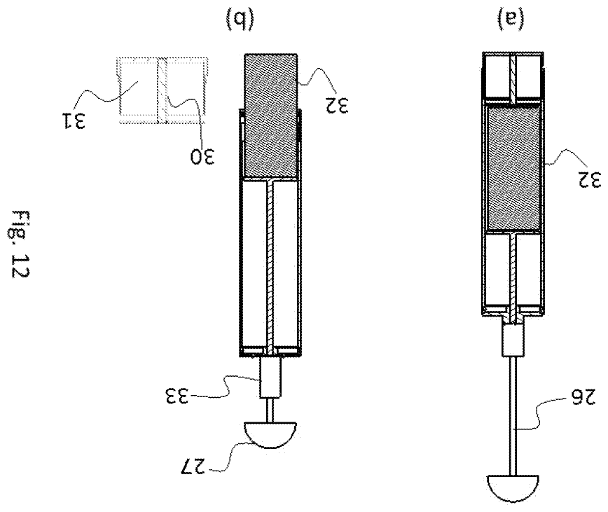

The operation of the appliance and the preparation of the food, as mentioned, require the use of the cooking capsule (4). The cooking capsule (4) is both end open to place the food inside. Due to contact with food, the capsule (4) interior, specifically, must be made of a material suitable for contact with food such as stainless steel. A distillate case (24), FIG. 9(a) is sealing fit with the main body (23) of the capsule (4). If the food is not in liquid farm, it must be so placed inside the capsule that it contacts the inner walls of the main body (23). To facilitate this process, there is a press (25), FIG. 11, which manually or mechanically squeezes the food into the capsule (4). The press (25) also acts as an extractor when extracting the food from the cooking capsule (4). The press (25) consists of a rod (26) with a handle (27) at its end for the user to exert pressure, while at the other end it has a pressure surface (28) with a size corresponding to the inside of the cooking capsule (4), so that it passes smoothly through it. The distillation case (24) may be internally provided with a food holding surface (29), FIG. 9(b), on which the food rests. Additionally there is a spacer (30), which separates the food from its distillates (31), FIG. 12(b), which are gathered at the lower part of the distillate case (24). After the cooking capsule (4) is opened and the distillate case (24) is removed from the main body (23), the cooked food (32) is extracted using the press (25). Separating the main body (23) from the distillate case (24) further facilitates their cleaning, either by the use of a brush, or by running water and detergents. At the same time, in an illustrative, but not limiting embodiment, the main body (23) of the cooking capsule (4) has a transport handle (33), FIG. 10, through which it is attached to the distillate case (24). Alternatively, there may be other ways to remove it from the device, such as refractory gloves. The modes of connection can be varied. For example, the transport handle (33) may have movable protrusions (34) fitting into indentions (40), FIG. 9, of the cooking capsule (4), securing the handle on the capsule. In an alternative embodiment the transport handle (33) may be combined with the press (25), FIG. 12(a), allowing the press to pass through the handle.

The distillate case (24) is sealed with the main body (23) by means of a suitable sealing means, such as for example a sealing ring, inserted between them. Components suitable to give a desired shape to the inside of the food can be fitted on the food holding surface (29) and the spacer (30). For example, if dough is cooked with a hole in the middle for subsequent stuffing insertion, a component with a cylindrical cross section corresponding to the desired hole for the dough may be fitted to the distillate case (24).

Inserting the cooking capsule (4) into the case (3) may leave the distillate case (24) out of range of the heat element (2), which in this case is of a tubular type electrical resistance, so that the distillates are not heated and affect the way the food is cooked, for example by the steam produced. If the distillation case (24) is also within the range of the heat element (2), then as it is evident, the contents of the case (24) will evaporate, thus affecting the way the food is cooked in the cooking capsule (4). As a result, for example, the food will be boiled or steamed and will absorb odours from the distillate case (24) liquids.

The device operation is controlled by a control system (35), FIG. 13, while its supply is controlled by a power supply (36). The control system consists of microcontrollers suitable for controlling the device's automates, as well as for connecting it to other peripheral devices such as computers, smart devices and mobile phones. The control system (35) is connected to a peripheral machine either by a serial communication cable or wirelessly through known technologies. Note that it is possible to connect more than one inventive device per peripheral device. The user can send information and setting instructions through the peripheral device to every connected inventive device, as well as receive information and/or visual and/or audible indications on the condition of the device or even the food cooking. It is also possible to record the history of device indications and/or settings. In addition, it is possible for the user to enter qualitative data on the food cooking resulting from the respective settings of the device. The purpose of recording in conjunction with the introduction of quality cooking data is to create a database for drawing conclusions on food cooking settings, such as preferred temperatures or cooking times per food.

Regardless of the connection to peripheral devices, the control system (35) may also have visual and/or audible indication functions. The visual indications can be visualized through lamps and/or a related display (37) and may include elements such as the state of the appliance and/or cooking process elements such as times, temperatures, cooking stage and energy consumption. Similarly, the audible indications alert the user regarding the state of the device and/or the cooking stage, the speakers or other suitable means, which may be available on the device's control system (35). The appliance also has buttons and/or switches to adjust its operation.

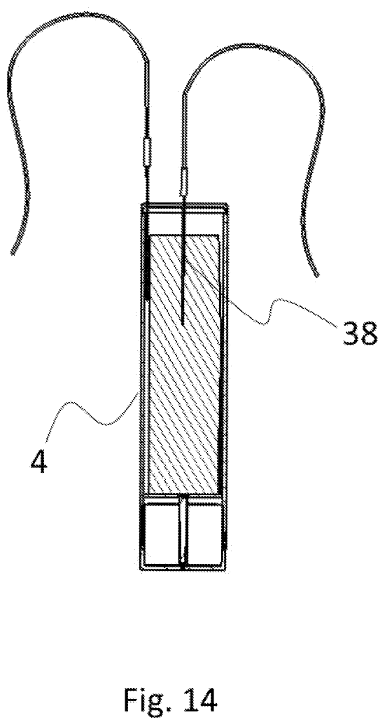

The appliance can be operated either by manual or automatic control of the control system (35). The control system is supported by software for easy user-device interaction. Automatic control using the mobile heat sensors (38), FIG. 14, or the sensors available, such as a weight measurement sensor, is capable of calculating with appropriate algorithms the energy consumed by the heat source to heat the food in relation to the energy that eventually reaches the temperature measurement points. As a result, the energy needed to enter the food to achieve the desired temperatures at the food points where the mobile heat sensors are placed (38) can be predicted by mathematical equations. Automatic control based on these predictions can activate the automation of the device, such as the cooling automation, to achieve the desired cooking effect at temperatures and alert the user with the corresponding indications. At the same time, a detection sensor (39) operated by the control system (35) may assist in automatically switching the device on and off. The detection sensor (39) is used to detect the insertion of the capsule (4) into the case (3). As such sensor can be used a weight sensor, a terminal switch, a magnetic switch or any other suitable switch, which could be able, in addition to detection, to act as a device on/off switch. Temperature measurement concerns the direct measurement of the food and/or the measurement of the components of the appliance involved in the cooking process, using at least one heat sensor or even thermoswitches located in the components of the device. The temperature of the food is measured using at least one mobile heat sensor with a probe (38) so that the user can place it from the upper open part of the cooking capsule (4) at any point on the food to control cooking inside or even on its surface.

The temperature measurement of the device components can be related to the heat element (2), the case (3), the cooking capsule (4) or even the ambient temperature. The above measurements can adjust the direct transition of the case (3) from a temperature to another, by activating the device's cooling or heating system.

It should be noted at this point that the invention was described with reference to illustrative embodiments, but not limited to. Therefore any change or modification in the shape, dimensions, morphology, materials and components used in construction and assembly, as long as they do not constitute a new inventive step and do not contribute to the technical development of the already known, are considered to be included in the purposes and aspirations of the present invention.

1. A cooking appliance for cooling and heating products inside a cooking capsule, consisting of an outer insulating housing (1), comprising at least one heat element (2), at least one cooling system and at least one case (3), with at least one detachable cooking capsule (4), consisting of a main body (23) and a distillate case (24), and an operating control system (35) of the appliance, characterized in that the cooking capsule (4) is inserted at least partially into the case (3) for the preparation of the food, under controlled heat transfer, by conduction, between the heat element (2), the case (3) and the detachable capsule (4) with the food.

2. A cooking appliance for cooling and heating products in a cooking capsule according to claim 1, characterized in that an insulation (10) is in between the housing (1) and the elements therein.

3. A cooking appliance for cooling and heating products in a cooking capsule according to claim 1, characterized in that the case (3) has external threads (5) to fit pipes (19) carrying fluid heated by the heat element (2) and cooled by the cooling system.

4. A cooking appliance for cooling and heating products in a cooking capsule according to claim 1, characterized in that the case (3) externally has protrusions (6) and a larger heating and cooling surface.

5. A cooking appliance for cooling and heating products in a cooking capsule according to claim 1, characterized in that the case (3) has external inlet/outlet holes (7) and internal cavities (8) for fluid passage and the internal cooling and heating thereof.

6. A cooking appliance for cooling and heating products in a cooking capsule according to claim 1, characterized in that it has covers (16) on the central base (12) and the upper and lower sides.

7. A cooking appliance for cooling and heating products in a cooking capsule according to claim 1, characterized in that the covers (16) have slots (17) for heat extraction.

8. A cooking appliance for cooling and heating products in a cooking capsule according to claim 1, characterized in that the cooling system has a tank (20) with a liquid circulation means (21) for forced cooling of the case (3).

9. A cooking appliance for cooling and heating products in a cooking capsule according to claim 1, characterized in that a press (25) moves inside the main body (23) of the cooking capsule (4) for the insertion and extrusion of the food.

10. A cooking appliance for cooling and heating products in a cooking capsule according to claim 1, characterized in that it has a detection sensor (39) for automatically activating and deactivating the operating control system (35).

11. A cooking appliance for cooling and heating products in a cooking capsule according to claim 1, characterized in that mobile heat sensors (38) are placed inside the device to control temperature.

12. A cooking appliance for cooling and heating products in a cooking capsule according to claim 6, characterized in that the covers (16) have slots (17) for heat extraction.
